(19) United States
(12) Patent Application Publication
(10) Pub. No.: US 2012/0224892 A1
(43) Pub. Date: Sep. 6, 2012

(54) BELT UNIT AND IMAGE FORMING APPARATUS

(75) Inventor: Takayuki TAKAZAWA, Tokyo (JP)

(73) Assignee: OKI DATA CORPORATION, Tokyo (JP)

(21) Appl. No.: 13/407,801

(22) Filed: Feb. 29, 2012

(30) Foreign Application Priority Data
Mar. 4, 2011 (JP) 2011-047382

(51) Int. Cl. G03G 15/01; B41M 5/40

(52) U.S. Cl. 399/302; 428/32.87

(57) ABSTRACT

A belt unit includes a belt whose surface has critical surface tension in a range from 15 N/m to 36 N/m, and a plurality of rollers around which the belt is stretched. With such a configuration, high image quality can be obtained.

### BACKGROUND OF THE INVENTION

The present invention relates to a belt unit having a belt (for example, an intermediate transfer belt), and an image forming apparatus using the belt unit.

A general image forming apparatus using an intermediate transfer belt includes an image forming unit having a photosensitive drum that bears a developer image, a primary transfer roller for transferring the developer image from the photosensitive drum to an intermediate transfer belt, a secondary transfer roller for transferring the developer image from the intermediate transfer belt to a printing medium, and a fixing unit for fixing the developer image to the printing medium (see, for example, Patent Document 1).

Patent Document 1: Japanese Laid-open Patent Publication No. 2010-134141 (paragraphs 0013-0021, 0032 and FIG. 1)

In the conventional art, there is a case where image quality is degraded.

### SUMMARY OF THE INVENTION

In an aspect of the present invention, it is intended to provide a belt unit and an image forming apparatus capable of enhancing image quality.

According to an aspect of the present invention, there is provided a belt unit including a belt whose surface has critical surface tension in a range from 15 N/m to 36 N/m, and a plurality of rollers around which the belt is stretched.

With such a belt unit, enhancement in image quality can be achieved.

According to another aspect of the present invention, there is provided an image forming apparatus including the above described belt unit and an image forming unit provided so as to face the belt unit. The image forming unit includes an image bearing body that bears a developer image.

Further scope of applicability of the present invention will become apparent from the detailed description given hereinafter. However, it should be understood that the detailed description and specific embodiments, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

In the attached drawings:

FIG. 1 is a schematic view showing a configuration of an image forming apparatus according to the first embodiment of the present invention;

FIG. 2 is a sectional view showing an intermediate transfer belt according to the first embodiment;

FIG. 3 shows a result of an evaluation test according to the first embodiment;

FIG. 4 is an explanatory view showing calculating method of a critical surface tension according to the first embodiment;

FIG. 5 is explanatory view showing a relationship between occurrence of dot hollow defect and indentation Young's modulus of the intermediate transfer belt according to the first embodiment;

FIG. 6 is explanatory view showing a relationship between occurrence of dot hollow defect and a critical surface tension of the intermediate transfer belt according to the first embodiment; and

FIG. 7 shows a result of an evaluation test according to the second embodiment.

### DETAILED DESCRIPTION OF THE PREFERRED EMBODIMENT

Hereinafter, a belt unit and an image forming apparatus according to embodiments of the present invention will be described with reference to drawings.

### First Embodiment

### <Configuration>

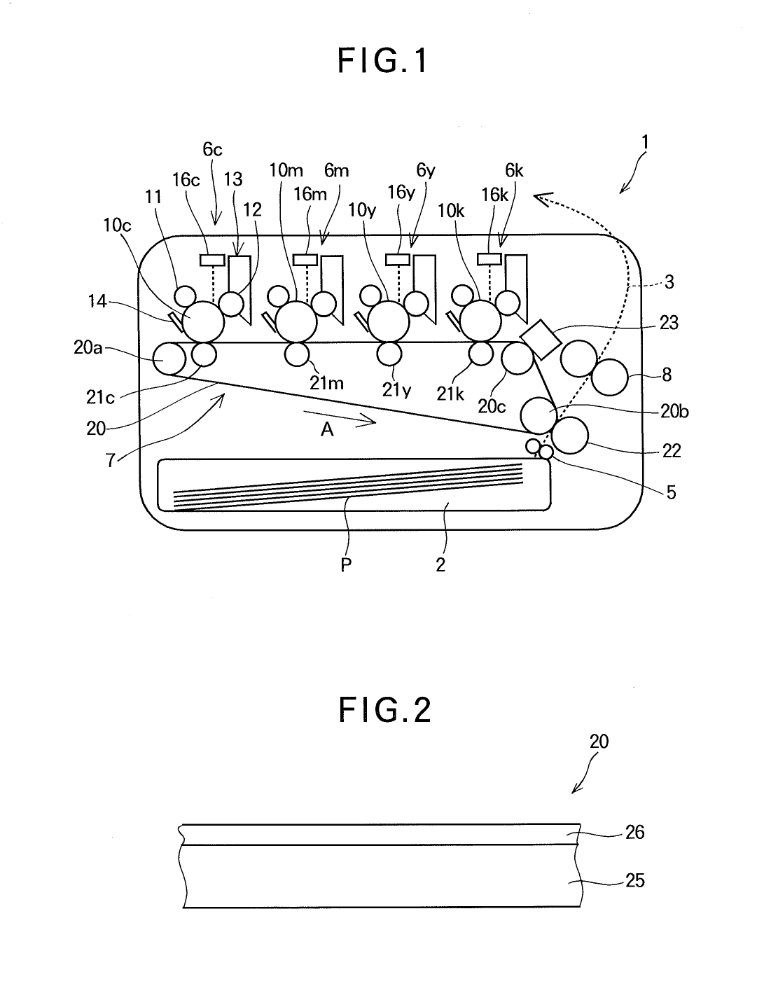

FIG. 1 is a schematic view showing a configuration of a printer 1 as an image forming apparatus according to the first embodiment of the present invention. The printer 1 is configured as an electrophotographic printer of an intermediate transfer type.

The printer 1 includes a medium cassette 2 as a medium storage portion in which sheets P (i.e., printing media) P are stored. The medium cassette 2 is detachably mounted to a lower part of a main body of the printer 1. The printer 1 further includes a medium feeding unit (for example, a pair of rollers) 5 for feeding the sheet P one by one out of the medium cassette 2 to a medium conveying path 3 shown by a dashed line in FIG. 1. The printer 1 further includes image forming units 6k, 6y, 6m and 6c that form toner images (i.e., developer images) of respective colors, a transfer unit 7 for transferring the toner image (formed by the image forming units 6k, 6y, 6m and 6c) to the sheet P, and a fixing unit 8 for fixing the toner image to the sheet P by application of heat and pressure.

The image forming units 6k, 6y, 6m and 6c store the toners (i.e., developers) of black (K), yellow (Y), magenta (M) and cyan (C). The image forming units 6k, 6y, 6m and 6c are arranged in this order along a direction in which an intermediate transfer belt 20 (described later) moves. The image forming units 6k, 6y, 6m and 6c have photosensitive drums 10k, 10y, 10m and 10c as image bearing bodies that rotate counterclockwise in FIG. 1. The photosensitive drums 10k, 10y, 10m and 10c are collectively referred to as the photosensitive drums 10.

Exposure heads 16k, 16y, 16m and 16c as exposure units are provided above and facing the photosensitive drums 10k, 10y, 10m and 10c of the image forming units 6k, 6y, 6m and 6c. The exposure heads 16k, 16y, 16m and 16c are collectively referred to as the exposure heads 16. Each of the exposure heads 16 has a light source such as an LED (Light Emitting Diode) or a laser diode, and emits light to expose the surface of the photosensitive drum 10 per dots to form a latent image on the surface of the photosensitive drum 10.

The image forming units 6k, 6y, 6m and 6c have the same configuration except the toner, and therefore are collectively referred to as the image forming units 6.

A configuration of the image forming unit 6 will be described. The image forming unit 6 includes the photosensitive drum 10 as an image bearing body on which a latent image is to be formed, a charging roller 11 as a charging unit that uniformly charges the surface of the photosensitive drum 10, a developing portion 13 that develops the latent image on the photosensitive drum 10 using the toner of a predetermined color to form a toner image, and a cleaning blade 14 that removes a residual toner that remains on the surface of the photosensitive drum 10 after a primary transfer process described later. The developing portion 13 includes a developing roller 12 as a developer bearing body.

The transfer unit 7 has an intermediate transfer belt 20 as a transfer body to which the toner image is transferred. The intermediate transfer belt 20 is stretched around a driving roller 20a, a supporting roller 20b and a supporting roller 20c. The transfer unit 7 further includes primary transfer rollers 21k, 21y, 21m and 21c as primary transfer members (i.e., first transfer members), a secondary transfer roller 22 as a secondary transfer member (i.e., a second transfer member). The transfer unit 7 further includes a cleaning portion 23 for removing a residual toner that remains on the surface of the intermediate transfer belt 20 after a secondary transfer process described later.

The primary transfer rollers 21k, 21y, 21m and 21c (used in a primary transfer process) are disposed so as to face the photosensitive drums 10k, 10y, 10m and 10c of the image forming units 6k, 6y, 6m and 6c. The primary transfer rollers 21k, 21y, 21m and 21c are collectively referred to as the primary transfer rollers 21. The primary transfer rollers 21 are pressed against the photosensitive drums 10 with a predetermined pressing force. Each primary transfer roller 21 is applied with a primary transfer voltage, and an electric field (i.e., a primary transfer electric field) is formed between the primary transfer roller 21 and the photosensitive drum 10. With the primary transfer electric field, the toner image is transferred from the photosensitive drum 10 to an outer circumferential surface of the intermediate transfer belt 20.

The secondary transfer roller 22 (used in a secondary transfer process) is disposed so as to face the supporting roller 20b (i.e., an opposing roller) via the intermediate transfer belt 20, and is pressed against the secondary transfer roller 22 with a predetermined pressing force. The secondary transfer roller 22 is applied with a secondary transfer voltage, and an electric field (i.e., a secondary transfer electric field) is formed between the secondary transfer roller 22 and the intermediate transfer belt 20. With the secondary transfer electric field, the toner image is transferred from the intermediate transfer belt 20 to the sheet P nipped between the intermediate transfer belt 20 and the secondary transfer roller 22.

The secondary transfer roller 22 is disposed on a downstream side of the medium feeding unit 5 in a conveying direction of the sheet P (referred to as a medium conveying direction) along the medium conveying path 3. The fixing unit 8 is disposed on a downstream side of the secondary transfer roller 22 in the medium conveying direction along the medium conveying path 3.

A belt unit (i.e., a belt device) according to the first embodiment includes the intermediate transfer belt 20, and also includes the driving roller 20a and the supporting rollers 20b and 20c around which the intermediate transfer belt 20 is stretched. The driving roller 20a is driven to rotate, and causes the intermediate transfer belt 20 to rotate in a direction shown by an arrow A (counterclockwise in FIG. 1). The supporting rollers 20b and 20c rotate following a rotation of the intermediate transfer belt 20. At a nip portion between the supporting roller 20b and the secondary transfer roller. 22, a moving direction of the intermediate transfer belt 20 is the same as the medium conveying direction (i.e., the conveying direction of the sheet P).

FIG. 2 a sectional view showing the intermediate transfer belt 20 according to the first embodiment. As shown in FIG. 2, the intermediate transfer belt 20 is an endless belt having a double layer structure. More specifically, the intermediate transfer belt 20 includes a base layer 25 composed of resin having electrical conductivity, and a surface layer 26 laminated on an outer circumference of the base layer 25. The surface layer 26 is composed of resin.

The intermediate transfer belt 20 composed of resin is produced in a simpler manner than a rubber belt having a resilient layer of synthetic rubber. Therefore, the intermediate transfer belt 20 composed of resin can produced inexpensively. Further, the intermediate transfer belt 20 composed of resin can be thinner than the rubber belt, and therefore faulty printing or image shift (i.e., color shift) due to variation in the thickness of the intermediate transfer belt 20 can be suppressed.

The intermediate transfer belt 20 of the first embodiment is produced as follows. First, polyimide (PI) resin is mixed with an appropriate amount of carbon black (i.e., electrical conductivity imparting agent) for imparting electrical conductivity. The resulting material is molded using a rotational molding method into a cylindrical member having a thickness of 80 μm and an outer diameter of 254 mm. Then, the cylindrical member is cut by a length of 345 mm, and the base layer 25 is obtained. Then, the base layer 25 is set to a jig having a certain size, and resin (for example, UV-curable resin) containing polyacryl as main chain is coated on the outer circumference of the base layer 25 to a predetermined thickness using a roll coating method. Then, the coated layer is cured (hardened) by UV (i.e., ultraviolet rays) irradiation, and the surface layer 26 having a thickness of 3 μm is obtained.

In this regard, resin of the base layer 25 is not limited to specific material. However, in terms of durability and mechanical characteristics, it is preferable to use material whose amount of deformation under tension (when the intermediate transfer belt 20 is driven) is in a certain range. Further, it is preferable to use material with which a side end of the intermediate transfer belt 20 is not subject to damage such as abrasion, bending and breaking due to repeated sliding contact with a skew prevention member. For example, the base layer 25 can be formed of polyamide-imide (PAI), polyvinylidene difluoride (PVDF), polyamide (PA), polybutylene terephthalate (PBT), polycarbonate (PC) and polyether sulfone (PES) or the like.

The base layer 25 can be formed by other methods than the rotational molding method. For example, extrusion molding, blown molding, centrifugal molding, dip molding or the like can be used depending on material of the base layer 25.

Further, the electrical conductivity imparting agent of the base layer 25 is not limited carbon black. For example, ion conductive agent can be added. As ion conductive agent, it is possible to use alkali metal salt such as sodium perchlorate, lithium perchlorate, lithium trifluoromethanesulfonate, lithium tetrafluoroborate, potassium thiocyanate, lithium thiocyanate, alkali earth metal salt, quaternaty ammonium salt, organic phosphate, boracic acid or the like.

The surface layer 26 can be formed by other methods than the roll coating method. For example, the surface layer 26 can be formed by dip coating, spray coating and the like. The surface layer 26 can be hardened by other methods than UV-irradiation. For example, the surface layer 26 can be hardened by thermal curing reaction depending on material of the surface layer 26.

Further, material of the surface layer 26 is not limited to the above described material. For example, the surface layer 26 can be formed of polyacril, polyester urethane, polyether urethane, polycarbonate, polybutylene terephthalate, polyethylene terephthalate, styrene compound, naphthalene compound, fluorine compound such as poly-tetra-fluoro-ethylene (PTFE), or the like.

A reason of occurrence of a phenomenon called “dot hollow defect” (i.e., a phenomenon that centers of dots become blank) will be herein described.

At the primary transfer process where the toner image is transferred from the photosensitive drum 10 to the intermediate transfer belt 20, the toner image is nipped by the photosensitive drum 10 and the intermediate transfer belt 20. In this state, the toner image is applied with a pressing force by the primary transfer roller 21, and therefore toner particles (forming the toner image) are applied with stress. The stress applied to toner particles is the largest at a center portion of each dot where toner particles are densely packed. The toner particles applied with the largest (excessive) stress undergo plastic deformation; and therefore adhesion force between the toner particles and adhesion force between the toner particles and the photosensitive drum 10 increase. For this reason, the toner particles are not likely to be transferred to the intermediate transfer belt 20. Further, the adhesion force (increased by plastic deformation) does not return to its original adhesion force even when the pressing force is removed. Therefore, the adhesion force between the photosensitive drum 10 and the toner particles becomes larger than Coulomb force applied to the toner particles by the primary transfer electric field formed by the primary transfer roller 21. Also for this reason, the toner particles are not likely to be transferred from the photosensitive drum 10 to the intermediate transfer belt 20.

In contrast, at a peripheral portion of each dot, stress is dispersed toward outside, and therefore the toner particles do not undergo plastic deformation. Therefore, the adhesion force increased by the stress (due to the pressing force by the primary transfer roller 21) returns to its original adhesion force when the pressing force is removed. Accordingly, the toner particles are transferred from the photosensitive drum 10 to the intermediate transfer belt 20 by action of the primary transfer electric field.

Same can be said to the secondary transfer process where the toner image is transferred from the intermediate transfer belt 20 to the sheet P by the secondary transfer electric field formed by the secondary transfer roller 22.

It is considered that a difference in the stress applied to the toner particles between at the center portion and at the peripheral portion of the dot results in the phenomenon called as dot hollow defect. Therefore, it is considered that the dot hollow defect can be suppressed by reducing the stress applied to the toner particles at the center portion of the dot.

In this embodiment, in order to suppress the dot hollow defect, focus is placed on surface characteristics of the surface layer 26 of the intermediate transfer belt 20. Particularly, focus is placed on hardness and releasability of the outer circumferential surface of the surface layer 26. Based on this consideration, the following evaluation test on the occurrence of the dot hollow defect has been performed.

### <Evaluation Test>

In the evaluation test of this embodiment, a hardness of the outer circumferential surface of the surface layer 26 was determined using indentation Young's modulus EIT. Releasability of the outer circumferential surface of the surface layer 26 was determined using critical surface tension γc.

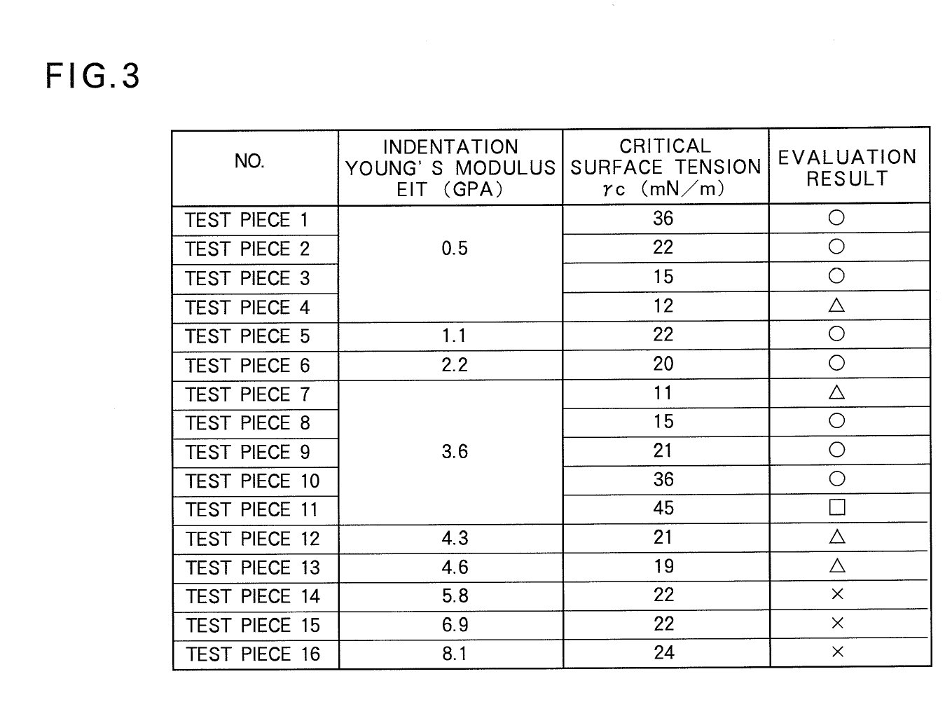

Further, in order to determine an optimum range of the surface characteristics of the outer surface 26, the indentation Young's modulus EIT was varied to 0.5, 1.1, 2.2, 3.6, 4.3, 4.6, 5.8, 6.9 and 8.1 (i.e., in 9 ways) as shown in FIG. 3 by changing a grade of the resin of the surface layer 26. Further, the critical surface tension γc was varied to 11, 12, 15, 19, 20, 21, 22, 24, 36 and 45 (i.e., in 10 ways) as shown in FIG. 3 by adding water-repellent agent (fluoride series or silicone series) of respective amounts to the resin of the surface layer 26. In particular, the critical surface tension γc was varied to 12, 15, 22 and 36 maintaining the indentation Young's modulus EIT to 0.5 GPa, and the critical surface tension γc was varied to 11, 15, 21, 36 and 45 maintaining the indentation Young's modulus EIT to 3.6 GPa. In this way, test pieces 1 through 16 (the intermediate transfer belt 20) having the surface layers 26 with different surface characteristics were produced as shown in FIG. 3.

In this regard, the base layer 25 of the intermediate transfer belt 20 used in the evaluation test had a thickness of 80 μm, and the surface layer 26 had a thickness of 3.0 μm. These values (thicknesses) were the same throughout the test pieces 1 through 16.

Further, the toner used in the evaluation test was formed by emulsion polymerization method. The toner contains styrene-acrylic copolymer as a major composition, and contains 9 weight part of paraffin wax. A mean volume diameter of the toner was 7.0 μm, and a sphericity of the toner was 0.95. These setting were selected in terms of enhancement in transfer rate in transfer processes, elimination of releasing agent in a fixing process, and enhancement in reproducibility and resolution in a developing process. These provide advantages in achieving image sharpness and high image quality.

Methods for measuring and calculating the surface characteristics of the intermediate transfer belt 20 will be herein described.

The indentation Young's modulus EIT of the outer circumferential surface of the surface layers 26 of the test pieces 1 through 16 were measured by means of specimens (i.e., indentation Young's modulus measurement specimens). Each specimen was prepared by forming the surface layer 26 having a thickness of 10 μm on a PI film or PVDF film. Then, the indentation Young's modulus BIT of the specimen was measured using a measuring apparatus “Nano Indenter G200” manufactured by Toyo Technica Corporation. A triangular pyramid indenter, i.e., Berkovichi indenter (TB 13289) was used as an indenter. The indenter was pressed against the surface of the specimen with a force of 0.5 mN (mill Newton), and the indentation Young's modulus was measured according to ISO 14577-1.

In this regard, a depth of the indentation of the indenter is several nm, and is sufficiently thinner than the thickness of the surface layer 26. Therefore, the indentation Young's modulus is not influenced by the characteristics of the base layer 25.

The releasability, i.e., the critical surface tension γc was measured using a contact angle method (i.e., Zismann method). A basic concept of the contact angle method is as follows. When a surface tension of liquid is greater than a surface of a measuring object (solid), a droplet of the liquid maintains its shape. In contrast, when the surface tension of the liquid is less than the surface of the measuring object, the droplet spreads outward (i.e., becomes well wet). Using a plurality of kinds of liquids having known surface tensions γ, contact angles θ of droplets of the respective liquids are measured. By plotting cosines of the contact angles e of the droplets of the respective liquids with respect to the surface tensions thereof, a straight line is obtained. An intersection between the straight line and a line of cos θ=1 (i.e., a completely wet condition) gives a critical surface tension γc. Therefore, as the critical surface tension γc is smaller, it means that releasability is high.

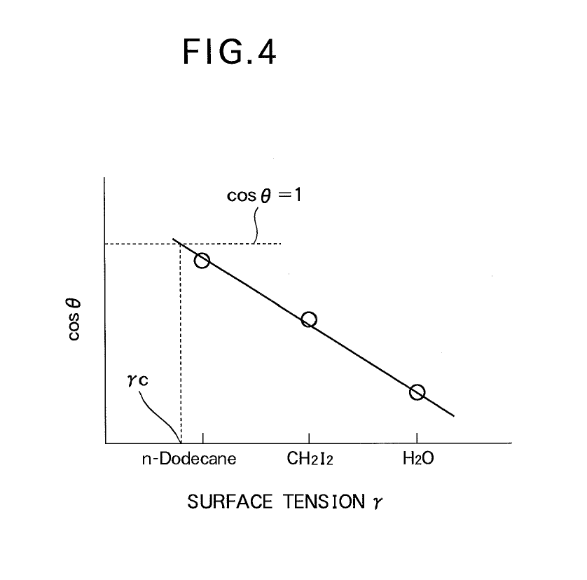

To be more specific, three kinds of liquids with different surface tensions γ were used: n-dodecane (25.0 mN/m), diiodomethane (50.8 mN/m) and pure water (72.8 mN/m). The contact angles θ of droplets of the respective liquids on the outer circumferential surface of the surface layer 26 of the intermediate transfer belt 20 were measured using a contact angle measuring apparatus “CA-X” manufactured by Kyowa Interface Science Company Limited. Cosines of the measured contact angles θ were plotted with respect to the surface tensions γ of the respective liquids as shown in FIG. 4 (Zismann-plot). In FIG. 4, an X-axis represents the surface tension γ, and a Y-axis represents cos θ. Based on plots, a strain line was determined by least square approximation. An intersection between the straight line and a line of cos θ=1 was determined as a critical surface tension γc of the outer circumferential surface of the surface layer 26.

The evaluation test on the occurrence of dot hollow defect using the test pieces 1 through 16 at the primary transfer process was performed as follows. Each of the test pieces 1 through 16 (the intermediate transfer belt 20) was mounted to the printer 1 shown in FIG. 1, and the single image forming unit (more specifically, the image forming unit 6y) was operated to form a toner image (i.e., a yellow toner image) on the outer circumferential surface of the surface layer 26 of the intermediate transfer belt 20. Then, the toner image on the surface layer 26 was observed using a stereoscopic microscope, and presence/absence of the dot hollow defect and a level of the dot hollow defect were determined.

In the evaluation test, the primary transfer voltage at the primary transfer process was 2900V, and a primary pressing force (generated by the primary transfer rollers 21) was 15.2 N. The secondary transfer voltage at the secondary transfer process was 2000V, and a secondary pressing force (generated by the supporting roller 20b) was 90 N.

Further, the evaluation test was performed under N/N environment (i.e., at temperature of 23° C. and humidity of 50%). A resolution of the printer 1 was set to 600 dpi (dot per inch).

Furthermore, the toner image to be formed on the outer circumferential surface of the surface layer 26 of the intermediate transfer belt 20 was a halftone image. In the halftone image, dots can be independently observed, unlike in a solid image. The halftone image is a so-called “2 by 2” image. More specifically, among 16 dots of four rows and four columns, four dots (of two rows and two columns) located at each of two diagonal corners of 16 dots are printed, and other dots are not printed.

The dots (220 dots for each toner image) are photographed at a magnification ratio of 100, and are binarized. Based on the binarized image, the number of dots where dot hollow defect occurs was counted.

Criteria in evaluating a level of the dot hollow defect were as follows. If the number of dots having the dot hollow defect was 0, the evaluation result was “◯” (excellent). If the number of dots having the dot hollow defect was greater than 0 but less than 10, the evaluation result was “Δ” (fair). If the number of dots having the dot hollow defect was greater than or equal to 10, the evaluation result was “×” (poor). If the dot hollow defect did not occur, but image blurring occurred at the secondary transfer process (where the toner is transferred from the intermediate transfer belt 20 to the sheet P), the evaluation result was “□”. The evaluation result is shown in FIG. 3.

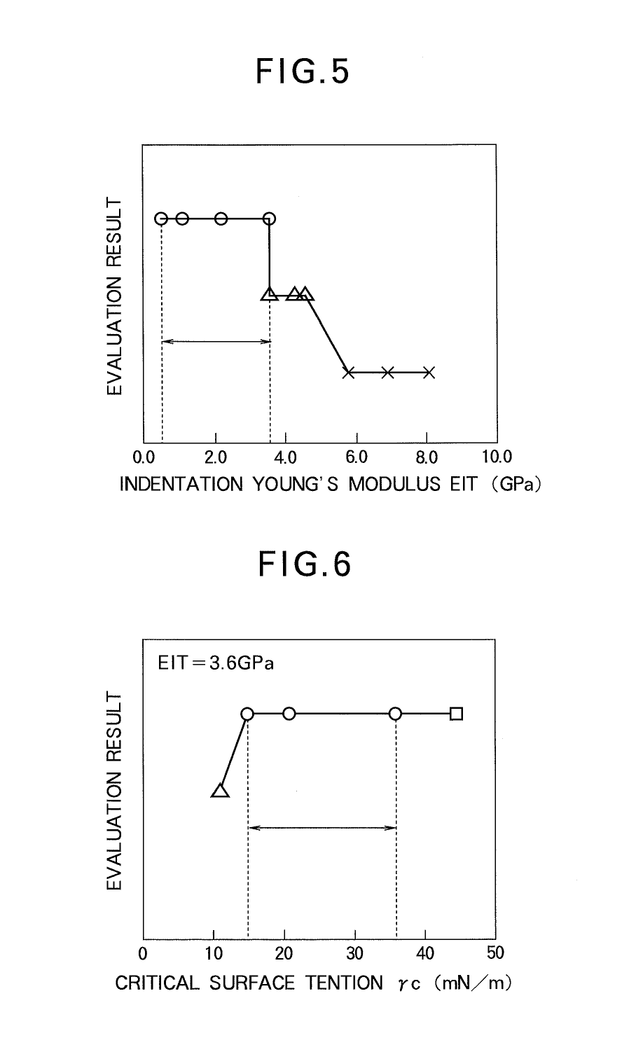

Further, FIG. 5 shows a relationship between the evaluation result of the occurrence of dot hollow defect and the indentation Young's modulus of the surface layer 26. FIG. 6 shows a relationship between the evaluation result of the occurrence of dot hollow defect and the critical surface tension of γc of the surface layer 26.

As shown in FIGS. 3 and 5, in order to prevent the occurrence of the dot hollow defect, it is necessary that the indentation Young' modulus EIT of the outer circumferential surface of the surface layer 26 of the intermediate transfer belt 20 is less than or equal to 3.6 GPa. Further, as shown in FIG. 6, in order to prevent occurrence of the dot hollow defect when the indentation Young's modulus EIT is 3.6 GPa, it is necessary that the critical surface tension γc of the outer circumferential surface of surface layer 26 is greater than or equal to 15 mN/m.

Further, if the indentation Young's modulus EIT is less than 0.5 GPa, the outer circumferential surface of the surface layer 26 exhibits tackiness, and therefore the toner tends to stick to the surface of the intermediate transfer belt 20. In such a case, it becomes difficult to remove the residual toner from the intermediate transfer belt 20 by the cleaning portion 23. For this reason, it is preferable that the indentation Young's modulus is greater than or equal to 0.5 GPa.

Further, if the critical surface tension γc exceeds 36 mN/m, image blurring occurs on the toner image transferred to the sheet P at the secondary transfer process. Fort this reason, it is preferable that the critical surface tension γc is less than or equal to 36 mN/m.

Accordingly, in order to prevent the occurrence of the dot hollow defect and to ensure effective transfer of the toner image from the intermediate transfer belt 20 to the sheet P, the indentation Young's modulus EIT of the outer circumferential surface of the surface layer 26 is preferably in a range of 0.5 GPa EIT 3.6 GPa, and the critical surface tension γc of the outer circumferential surface of the surface layer 26 is preferably in a range of 15 mN/m≦γc≦36 mN/m.

### <Consideration>

As described above, in the first embodiment, the indentation Young's modulus EIT of the outer circumferential surface of the surface layer 26 is less than or equal to 3.6 GPa, and therefore the force applied to the toner particles in the primary transfer process can be absorbed or dispersed by the surface layer 26. Accordingly, the dot hollow defect can be prevented.

Further, since the critical surface tension γc of the surface layer 26 is greater than or equal to 15 mN/m, a gap in releasability between the photosensitive drum 10 and the intermediate transfer belt 20 can be reduced. Therefore, the toner image can be effectively transferred to the intermediate transfer belt 20 by the action of the primary transfer electric field.

In contrast, if the indentation Young's modulus EIT of the outer circumferential surface of the surface layer 26 is greater than 3.6 GPa, the stress applied to the toner particles cannot be sufficiently absorbed and dispersed, and therefore the toner particles at the center portion of the dot may adhere to the surface of the photosensitive drum 10 (i.e., may not be transferred to the intermediate transfer belt 20), which may result in the occurrence of the dot hollow defect.

Further, if the critical surface tension γc of the outer circumferential surface of the surface layer 26 is less than 15 mN/m, releasability of the intermediate transfer belt 20 with respect to the toner may increase, and a distance in releasability between the photosensitive drum 10 and the intermediate transfer belt 20 increases. For this reason, the toner particles may adhere to the photosensitive drum 10 with an adhesion force greater than Coulomb force applied by the transfer electric field. In such a case, the toner particles (at the center portion of the dot) may not be transferred to the intermediate transfer belt 20, and the dot hollow defect may occur.

Furthermore, if the indentation Young's modulus of the outer circumferential surface of the surface layer 26 of the intermediate transfer belt 20 is less than 0.5 GPa, the dot hollow defect is enhanced, but the toner layer is not likely to be transferred from the intermediate transfer belt 20 to the sheet P in the secondary transfer process. The reason is considered to be as follows. If the indentation Young's modulus of the surface layer 26 is less than 0.5 GPa, the surface of the surface layer 26 is slightly deformed when the surface layer 26 is pressed by the supporting roller 20b and the secondary transfer roller 22. In this state, a contact area where the surface layer 26 contacts the toner particles increases, and therefore the adhesion force between the intermediate transfer belt 20 and the toner particles increases.

In addition, if the critical surface tension γc of the surface of the surface layer 26 of the intermediate transfer belt 20 is greater than 36 mN/m, the adhesion force between the surface layer 20 and the toner particles increases. In such a case, the toner particles are not sufficiently transferred to the sheet P in the secondary transfer process, and image defect (for example, image blurring) occurs.

### <Advantages>

As described above, according to the first embodiment of the present invention, the critical surface tension γc of the outer circumferential surface of the surface layer 26 of the intermediate transfer belt 20 is in a range of 15 mN/m≦γc≦36 mN/m. Therefore, it becomes possible to enhance transferability of the toner image from the photosensitive drum 10 to the intermediate transfer belt 20 and from the intermediate transfer belt 20 to the sheet P.

Further, the indentation Young's modulus EIT of the outer circumferential surface of the surface layer 26 is in a range of 0.5 GPa≦EIT≦3.6 GPa. Therefore, the force applied to the toner particles in the first transfer process and the second transfer process can be absorbed or dispersed by the surface layer 26. Accordingly, the dot hollow defect can be prevented.

### Second Embodiment

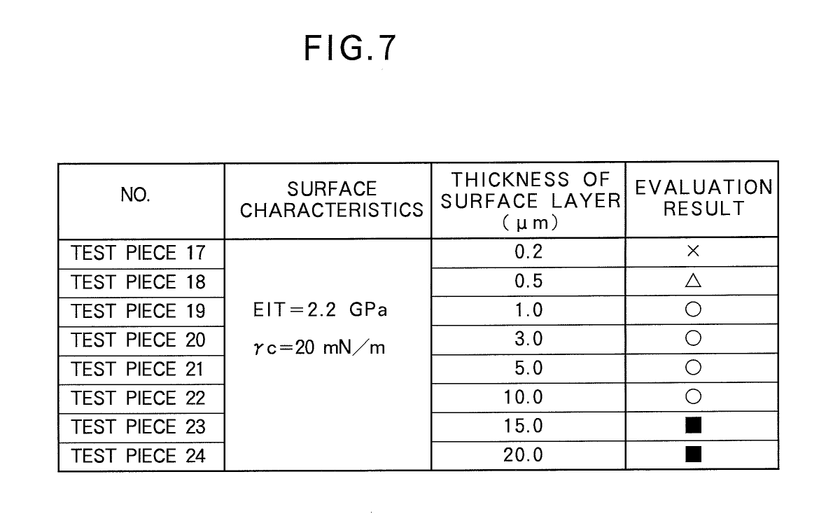

The second embodiment of the present invention will be described with reference to FIG. 7. Elements which are the same as those of the first embodiment area assigned the same reference numerals, and duplicate explanations will be omitted.

In the second embodiment, focus is placed on a thickness of the surface layer 26, and an evaluation test on the occurrence of dot hollow defect was performed in a similar manner to the evaluation test described in the first embodiment.

The intermediate transfer belt 20 used in the evaluation test of the second embodiment was configured by forming the surface layer 26 on the base layer 25. The base layer 25 was composed of PVDF, and had a thickness of 140 μm. The thickness of the surface layer 26 was varied to 0.2, 0.5, 1.0, 3.0, 5.0, 10.0, 20.0 μm (i.e., in 8 ways) as shown in FIG. 7. In this way, test pieces 17 through 24 (the intermediate transfer belt 20) having the surface layers 26 with different surface characteristics were produced as shown in. FIG. 7.

The intermediate transfer belt 20 used in the evaluation test had the indentation Young's modulus EIT of 2.2 GPa and a critical surface tension γc of 20 mN/m. These values (EIT and γc) were the same throughout the test pieces 17 through 24. Other conditions of the evaluation test and methods for measuring and calculating the surface characteristics were the same as those described in the first embodiment.

Criteria in evaluating a level of the dot hollow defect were as follows. If the number of dots having the dot hollow defect was 0, the evaluation result was “◯” (excellent). If the number of dots having the dot hollow defect was greater than 0 but less than 10, the evaluation result was “Δ” (fair). If the number of dots having the dot hollow defect was greater than or equal to 10, the evaluation result was “×” (poor). If the dot hollow defect did not occur, but crack occurred on the surface layer 26, the evaluation result was “ [symbol] ”. The evaluation result is shown in FIG. 7.

As shown in FIG. 7, the occurrence of the dot hollow defect at the primary transfer process can be suppressed when the thickness of the surface layer 26 is thicker than or equal to 1 μm.

In contrast, if the thickness of the surface layer 26 is thinner than 1 μm, the dot hollow defect occurs (see, the test pieces 17 and 18 shown in FIG. 7). This is because, when the surface layer 28 is too thin, the stress applied to the toner particles cannot be sufficiently absorbed or dispersed, which results in the occurrence of the dot hollow defect.

Further, as the surface layer 26 becomes thicker, a capability of the surface layer 26 to follow the base layer 25 decreases. Therefore, if the surface layer 26 is thicker than 10 μm, micro crack may occur on the surface of the surface layer 26 (see, the test pieces 23 and 24 shown in FIG. 7).

Furthermore, as the surface layer 26 becomes thicker, an electric resistance of the intermediate transfer belt 20 increases, and therefore transfer scattering or image blurring may occur. The occurrence of the transfer scattering and image blurring can be suppressed by imparting electrical conductivity to the surface layer 26. However, if electrical conductivity is imparted to the surface layer 26, it may affect the indentation Young's modulus EIT and the critical surface tension γc, which is not preferable.

In the second embodiment, the evaluation result when the indentation Young's modulus EIT is 2.2 GPa and the critical surface tension γc is 29 mN/m has been described. However, the same evaluation result as that of FIG. 7 was obtained when the indentation Young's modulus EIT is in a range from 0.5 to 3.6 GPa, and the critical surface tension γc is in a range from 15 to 36 mN/m.

Therefore, in order to prevent occurrence of the dot hollow defect and occurrence of crack on the surface layer 26 of the intermediate transfer belt 20, it is preferable that the indentation Young's modulus EIT of the surface layer 26 in a range of 0.5 GPa≦EIT≦3.6 GPa, the critical surface tension γc is preferably in a range of 15 mN/m≦γc≦36 mN/m, and the thickness of the surface layer 26 is in a range from 1 to 10 μm.

As described above according to the second embodiment of the present invention, the thickness of surface layer 26 of the intermediate transfer belt 20 is in a range from 1 to 10 μm, and therefore occurrence of the dot hollow defect and occurrence of crack on the surface layer 26 can be suppressed. Accordingly, it becomes possible to obtain excellent dots for a long time period.

In the above described first and second embodiments, the intermediate transfer belt has been described as an example of the belt. However, it is possible to use other belt such as a direct transfer belt.

In the above described embodiments, the image forming apparatus is configured as the color printer. However, the image forming apparatus can be configured as a monochrome printer. Further, the image forming apparatus can be configured as a copier, a facsimile machine, a MFP (Multifunction Peripheral) or the like.

While the preferred embodiments of the present invention have been illustrated in detail, it should be apparent that modifications and improvements may be made to the invention without departing from the spirit and scope of the invention as described in the following claims.

What is claimed is:-:

1. A belt unit comprising:
a belt whose surface has critical surface tension in a range from 15 N/m to 36 N/m, and
a plurality of rollers around which said belt is stretched.

2. The belt unit according to claim 1, wherein said belt has indentation Young's modulus in a range from 0.5 GPa to 3.6 GPa.

3. The belt unit according to claim 2, wherein said indentation Young's modulus is measured by pressing an indenter against a surface of said belt with a force of 0.5 mN.

4. The belt unit according to claim 3, wherein said indenter is a triangular pyramid indenter.

5. The belt unit according to claim 1, wherein said belt includes at least a base layer and a surface layer.

6. The belt unit according to claim 5, wherein said surface layer has a thickness in a range from 1 to 10 μm.

7. The belt unit according to claim 5, wherein said base layer is formed of resin.

8. The belt unit according to claim 5, wherein said surface layer is formed of resin.

9. The belt unit according to claim 5, wherein said surface layer is formed of UV-curable resin.

10. The belt unit according to claim 1, wherein said belt bears a developer image on a surface of said belt.

11. The belt unit according to claim 5, wherein said base layer contains resin and electrical conductivity imparting agent, and
said surface layer contains resin and water-repellent agent.

12. An image forming apparatus comprising:
said belt unit according to claim 1, and
an image forming unit provided so as to face said belt unit, said image forming unit including an image bearing body that bears a developer image.

13. The image forming apparatus according to claim 12, further comprising a roller provided so as to face said image bearing body via said belt.

14. The image forming apparatus according to claim 12, further comprising a first transfer member provided so as to face said image bearing body via said belt.

15. The image forming apparatus according to claim 14, wherein said first transfer member is a primary transfer member for transferring a developer image from said image bearing body to said belt.

16. The image forming apparatus according to claim 12, further comprising a roller so as to face at least one of said plurality of rollers via said belt.

17. The image forming apparatus according to claim 12, further comprising a second transfer member provided so as to face at least one of said plurality of rollers via said belt.

18. The image forming apparatus according to claim 17, wherein said transfer member is a secondary transfer member for transferring a developer image from said belt to a printing medium.

19. The image forming apparatus according to claim 12, further comprising:
a primary transfer member for transferring a developer image from said image bearing body to said belt, and
a secondary transfer member for transferring said developer image from said belt to a printing medium.
